(19) United States
(12) Patent Application Publication
(10) Pub. No.: US 2019/0358875 A1
(43) Pub. Date: Nov. 28, 2019

(54) INJECTION MOLDING APPARATUS AND METHOD TO REDUCE BIREFRINGENCE

(71) Applicant: VISTEON GLOBAL TECHNOLOGIES, INC., VAN BUREN TOWNSHIP, MI (US)

(72) Inventor: KAZUHIRO FUKUZAWA, KANAGAWA-PREF. (JP)

(21) Appl. No.: 15/986,081

(22) Filed: May 22, 2018

(51) Int. Cl. B29C 45/02; B29C 45/00; B29C 45/58; B29C 45/57

(52) U.S. Cl. CPC B29C 45/021; B29C 45/0025; B29C 2045/577; B29C 45/581; B29C 45/572; B29C 45/586

(57) ABSTRACT

A molding apparatus and method operation for making a molded part are provided. The molding apparatus includes a mold core extending between a generally flat lower surface and an upper surface defining a runner, a fan gate, and a part cavity for forming the molded part. The mold core includes an inner surface defining a plunger cavity extending into the mold core from the upper surface and having a uniform cross-section parallel to the upper surface and open to the gate. A plunger is slidably disposed within the plunger cavity for pulling material from the gate into the plunger cavity. A first pin extends through a first bore in the mold core to move the plunger within the plunger cavity. A hydraulic cylinder interacts with an ejector plate to move the first pin. A second pin also extends through the mold core and is movable perpendicular to the upper surface.

### BACKGROUND

Molded parts of plastic materials, such as Polycarbonate and Poly Methyl Methacrylate, commonly suffer from optical defects such as birefringence caused by stress from differential shrinkage between different areas of the molded part. Specifically, areas of the molded part proximate to a gate commonly have over packing or over pressurization, since material can be injected therein until the last stage of the mold holding and curing process due to the highest material temperature there.

It is a goal of the present disclosure to reduce internal stresses in molded parts due to differential shrinkage in a molded part and to thereby minimize birefringence in molded parts.

### SUMMARY

A molding apparatus includes a mold core extending between an upper surface and a lower surface. The upper surface defines a runner for transferring liquid material to a part cavity to form the molded part, with a gate providing fluid communication between the runner and the part cavity. The mold core includes an inner surface defining a plunger cavity extending into the mold core from the upper surface and open to the gate.

A first pin includes a first shaft extending transverse to the lower surface through a first bore in the mold core to a plunger which is slidably disposed within the plunger cavity. The plunger sealingly engages the inner surface of the plunger cavity and operates to draw the liquid material from the gate into the plunger cavity to reduce the fluid pressure within the gate.

A method for making a molded part with a molding apparatus is also provided, and which includes providing a mold core extending between an upper surface and a lower surface; and transferring liquid material through a runner to a part cavity within the upper surface of the mold core to fill the part cavity with the liquid material. The method also includes the steps of conveying the liquid material through a gate between the runner and the part cavity; hardening the liquid material within the part cavity to form the molded part having the shape of the part cavity; pulling a first pin through a first bore in the mold core away from the gate; and pulling a plunger through a plunger cavity in fluid communication with the gate by the pulling of the first pin through a first bore in the mold core. The method further includes drawing a quantity of the liquid material from the gate into the plunger cavity by moving the plunger through the plunger cavity after the part cavity is filled with the liquid material and before the liquid material within the part cavity has completely hardened, and thereby reducing the pressure of the liquid material within the gate.

### BRIEF DESCRIPTION OF THE DRAWINGS

Further details, features and advantages of designs of the invention result from the following description of embodiment examples in reference to the associated drawings.

FIG. 1 is a top view of a molded part of the prior art;

FIG. 2A is a cut-away side view of a molding apparatus in accordance with the present disclosure and in a first state;

FIG. 2B is a cut-away side view of the molding apparatus of FIG. 2A in a second state;

FIG. 3A is an enlarged section of a cut-away side view of a molding apparatus of the present disclosure and in a first position;

FIG. 3B is a top view of the enlarged section of FIG. 3A;

FIG. 4A is an enlarged section of a cut-away side view of a molding apparatus of the present disclosure and in a second position;

FIG. 4B is a top view of the enlarged section of FIG. 4A;

FIG. 4C is a perspective view of the enlarged section of FIG. 4A;

FIG. 5 is a top view of a cut-away top view of a section of an alternative embodiment molding apparatus of the present disclosure;

FIG. 6 is a top view of a cut-away top view of a section of another alternative embodiment molding apparatus of the present disclosure;

FIG. 7A is a flow chart of steps in a method for making a molded part with a molding apparatus; and

FIG. 7B is a continuation of the flow chart of FIG. 7A.

### DETAILED DESCRIPTION

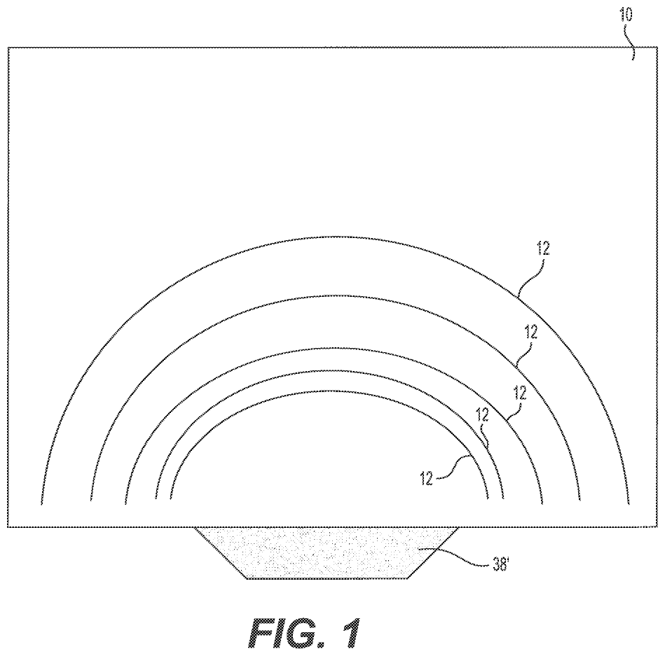

Recurring features are marked with identical reference numerals in the figures. A molding apparatus 20 and method of operation for making a molded part 10 are disclosed. FIG. 1 shows a molded part 10 of the prior art including stress lines 12 which may cause undesirable optical characteristics such as birefringence.

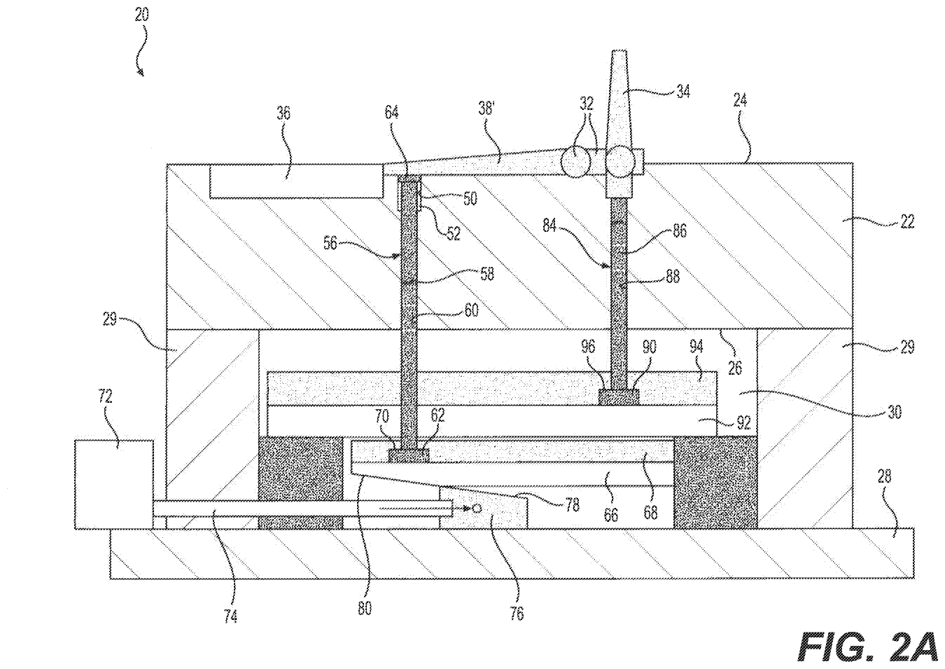

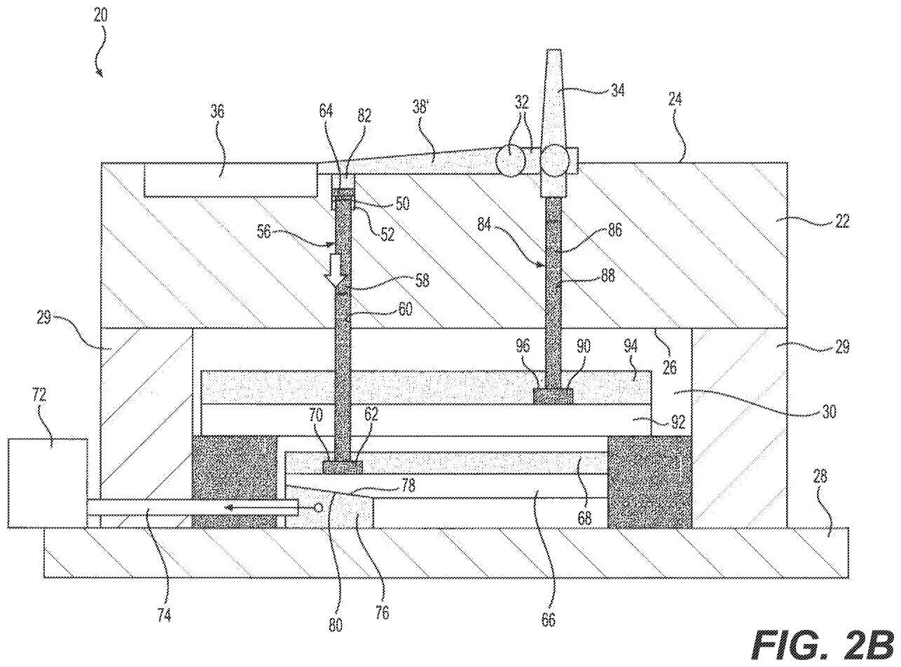

As generally shown in FIGS. 2A and 2B, the molding apparatus 20 includes a mold core 22 of metal having a generally rectangular shape extending between an upper surface 24 and a generally flat lower surface 26. A base plate 28 of metal having a generally flat shape with a rectangular cross-section supports the mold core 22. A plurality of risers 29 hold the mold core 22 upon and spaced away from the base plate 28, together defining an ejector compartment 30 between the mold core 22 and the base plate 28 and between the plurality of risers 29.

As shown in the cut-away views of FIGS. 2A and 2B, a runner 32 having a generally cylindrical shape is provided for transferring liquid material from a sprue 34 to a part cavity 36 for forming the molded part 10, with a gate 38 providing fluid communication between the runner 32 and the part cavity 36. The liquid material may be a melted plastic such as, Polycarbonate or Poly Methyl Methacrylate. The molded part 10 may be transparent or translucent and may be required to have certain optical properties which can be adversely impacted by internal stresses generated during the molding process. The upper surface 24 of the mold core 22 defines, at least in part, each of the runner 32, the sprue 34, the part cavity 36, and the gate 38. A cavity plate (not shown) may be disposed above the mold core 22 to enclose one or more of the runner 32, the sprue 34, the part cavity 36, and/or the gate 38.

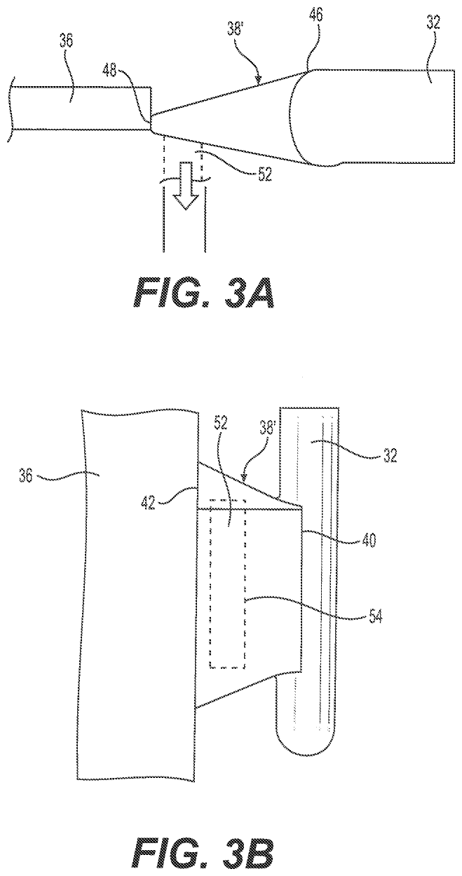

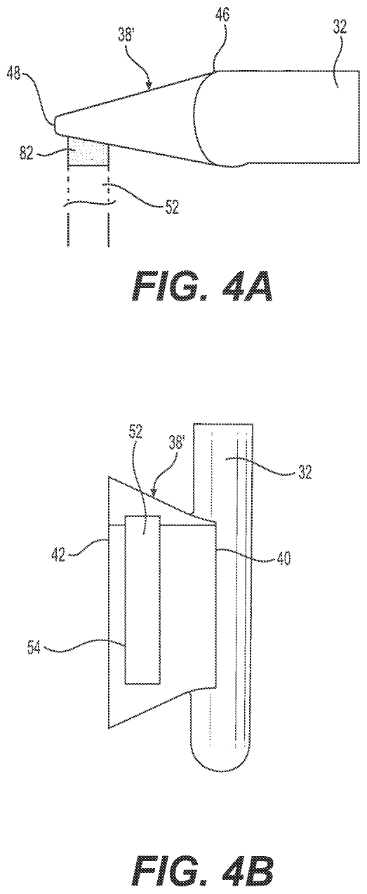

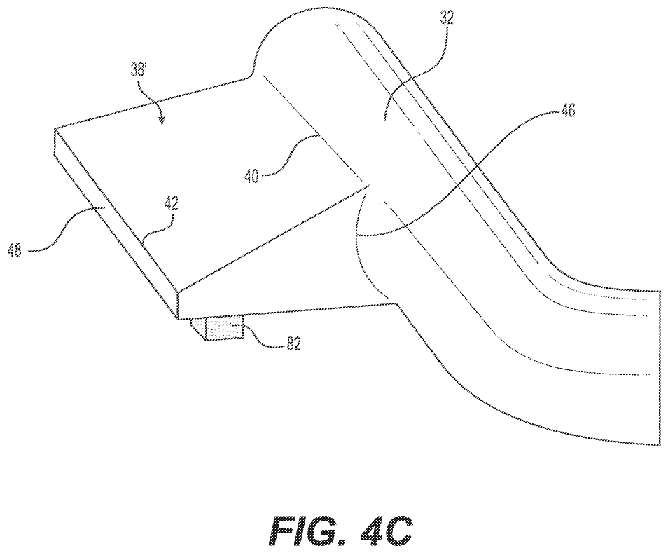

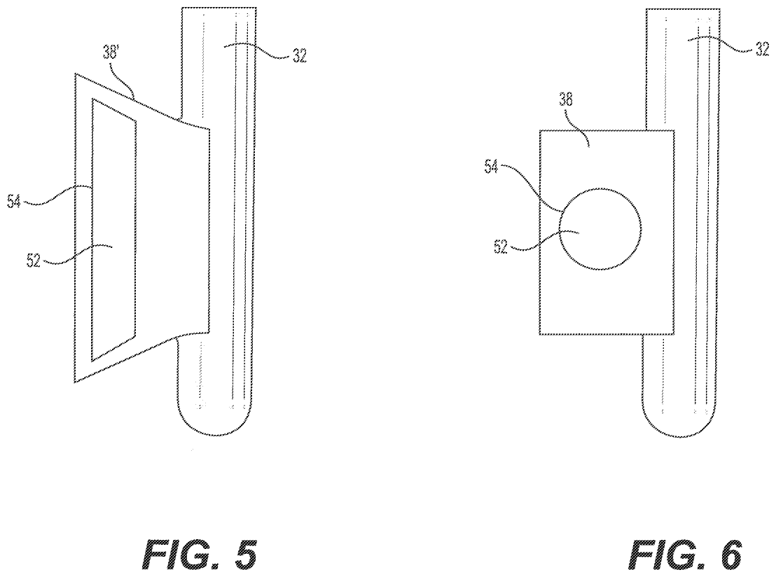

As best shown in FIGS. 4A-4C, the gate 38 may be a fan gate 38′ having a generally trapezoidal cross-section parallel to the lower surface 26, and extending between a narrow edge 40 adjoining the runner 32 and a wide edge 42 larger than the narrow edge 44 adjoining the part cavity 36. As best shown in FIGS. 3A and 4A, the fan gate 38′ also has a generally trapezoidal cross-section perpendicular to the lower surface 26 extending from a thick end 46 adjoining the runner to a thin end 48 adjoining the part cavity 36. In this way, the fan gate maintains a generally constant cross-sectional area between the runner 32 and the part cavity 36, allowing material passing therethrough to maintain a constant velocity at a constant flow rate.

As shown in FIGS. 2A and 2B, the mold core 22 includes an inner surface 50 defining a plunger cavity 52 extending into the mold core 22 from the upper surface 24 and having a uniform cross-section 54 parallel to the upper surface 24 and open to the gate 38.

As also shown in FIGS. 2A and 2B, the molding apparatus 20 includes a first pin 56 including a first shaft 58 having an elongate cylindrical shape and extending transverse to the lower surface 26 through a first bore 60 in the mold core 22. The first bore 60 extends into the plunger cavity 52 opposite the gate 38. The first pin 56 also includes a first head 62 having a generally cylindrical shape wider than the first shaft 56. The first pin 56 also includes and/or is fixed to a plunger 64 opposite the first head 62. The plunger 64 is slidably disposed within the plunger cavity 52 and sealingly engaging the inner surface 50. In this way, the first pin 56 causes the plunger 64 to move within the plunger cavity 52 for pulling material into the plunger cavity 52 or for pushing material out of the plunger cavity 52.

As shown in FIGS. 2A and 2B, the uniform cross-section 54 of the plunger cavity 52 is preferably larger than a cross section of the first bore 60. However, the uniform cross-section 54 may be smaller or the same size as the first bore 60.

As also shown in FIGS. 2A and 2B, the molding apparatus 20 also includes a first ejector plate 66 is disposed within the ejector compartment 30 and engages the first head 62 of the first pin 56 opposite the first shaft 58 and is movable transverse to the lower surface 26 for pushing the first pin 56 into the first bore 60 of the mold core 22. A first retainer plate 68 is disposed upon and fixed to the first ejector plate 66 proximate to the mold core 22 and surrounding the first head 62 of the first pin 56 for engaging a first annular shoulder 70 of the first head 62 opposite the first ejector plate 66 for pulling the first pin 56 out from the first bore 60 of the mold core 22.

As shown in FIGS. 2A and 2B, the molding apparatus 20 also includes a hydraulic cylinder 72 to move a hydraulic ram 74 in a direction parallel to the lower surface 26 and to slide a block 76 between the base plate 28 and the first ejector plate 66, with the block 76 defining a ramp 78 engaging a sloped lower edge 80 of the first ejector plate 66 for causing the first pin 56 to move away from the upper surface 24 in response to the hydraulic ram 74 being retracted toward the hydraulic cylinder 72, and to thereby cause the plunger 64 to move into the plunger cavity 52, pulling liquid material from the gate 38 and reducing the internal pressure within the gate 38. The block 76 may include other features (not shown) such as a dovetail or a slot to engage a corresponding structure on the first ejector plate 66 for pulling the first plate 66 away from the mold core 22, and thereby pulling the plunger 64 downwardly into the plunger cavity 52. As shown in FIG. 2B, liquid material within the plunger cavity 52 subsequently hardens into a slug 82 having the shape of the plunger cavity 52.

Preferably, the fluid pressure in the gate 38 remains positive relative to the pressure in the part cavity 36 as is typical for injection molding. By operation of the piston, the fluid pressure is just reduced at the critical time after the part cavity 36 is partially or completely filled and before the liquid material therein has completely solidified, thereby reducing internal stresses in the molded part 10.

The plunger 64 of the present disclosure is particularly effective in reducing internal stresses in molded parts 10, and therefore birefringence, when used in conjunction with a fan gate 38′, which minimizes the material flow speed into the part cavity 36.

FIG. 2A illustrates the molding apparatus 20 in a first state with the hydraulic ram 74 and the block 76 in an extended position, biasing the first ejector plate 66 in a raised position toward the mold core 22. The first pin 56 is in a corresponding extended position, with the plunger 64 in the plunger cavity 52 proximate to the gate 38′. FIG. 2B illustrates the molding apparatus 20 in a second state with the hydraulic ram 74 and the block 76 in an retracted position, biasing the first ejector plate 66 in an lowered position away from the mold core 22. The first pin 56 is in a corresponding retracted position, with the plunger 64 in the plunger cavity 52 spaced apart from the gate 38′ for drawing liquid material out of the gate 38′ and into the plunger cavity 52. The term “liquid material” as used in the present disclosure is used to refer to any material which is sufficiently fluid to be conveyed during the injection molding process or such a material that has not reached a fully hardened or cured state. It may include liquids or semi-solid materials such as slurries or other highly viscous fluids.

This extraction of the liquid material from the gate 38 reduces internal stresses in the molded part 10 that can result from an overpacking condition that can otherwise result from the liquid material continuing to be injected throughout the holding phase of the molding process while the liquid material solidifies within the part cavity 36. In other words, areas of the part cavity 36 that are adjacent to the gate 38 generally have the highest material temperature and are therefore the last to solidify in the holding phase of the molding process. The molding apparatus 20 of the present disclosure, therefore reduces volumetric shrinkage deviation which is one of the root causes of birefringence in the molded parts 10 produced.

As shown in FIGS. 2A and 2B, the molding apparatus 20 also includes a second pin 84 including a second shaft 86 having an elongate cylindrical shape extending transverse to the lower surface 26 through a second bore 88 in the mold core 22 and extends to the upper surface 24 of the mold core 22 to engage one of the runner 32 or the sprue 34 or the molded part 10 for removal from the mold core 22 after the liquid material therein has solidified. The second pin 84 includes a second head 90 having a generally cylindrical shape wider than the second shaft 56. A second ejector plate 92 is disposed within the ejector compartment 30 and engaging the second head 90 of the second pin 84 opposite the second shaft 86 and being movable transverse to the lower surface 26 for pushing the second pin 86 into the second bore 88 of the mold core 22. The second pin 84 may function as a traditional ejector pin commonly used in injection molding.

As also shown in FIGS. 2A and 2B, a second retainer plate 94 is disposed upon and fixed to the second ejector plate 86 proximate to the mold core 22 and surrounding the second head 90 of the second pin 84 for engaging a second annular shoulder 96 of the second head 90 opposite the second ejector plate 92 for pulling the second pin 84 out from the second bore 88 of the mold core 22.

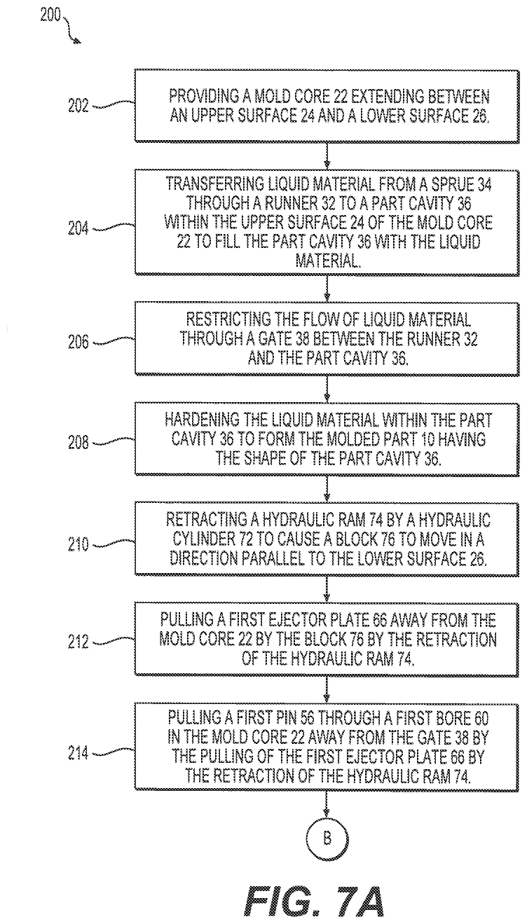

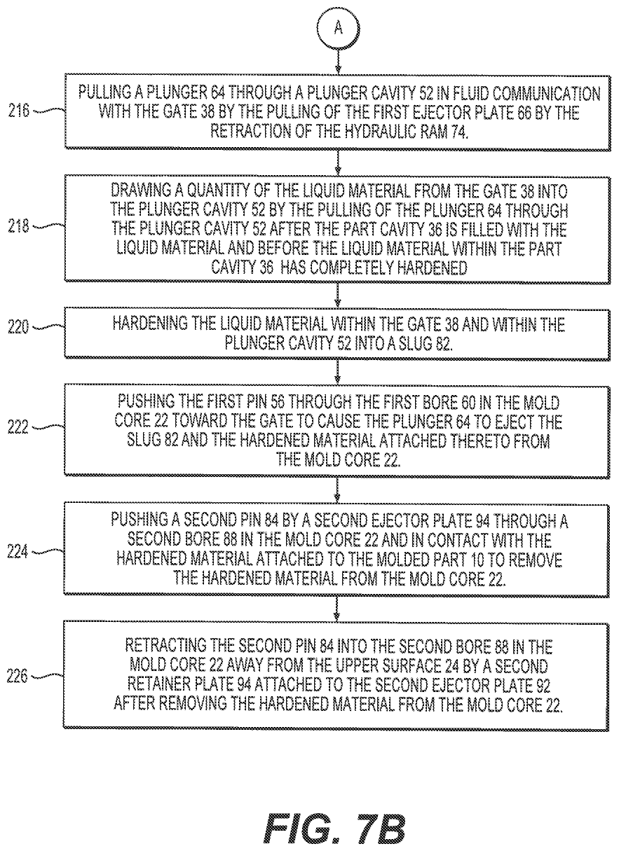

As shown in the flow charts of FIGS. 7A and 7B, the present disclosure includes a method 200 for making a molded part 10 with a molding apparatus. The method 200 includes 202 providing a mold core 22 extending between an upper surface 24 and a lower surface 26. The mold core 22 is shown in cross-section in FIGS. 2A and 2B and may be a generally rectangular block of metal.

The method 200 also includes 204 transferring liquid material from a sprue 34 through a runner 32 to a part cavity 36 within the upper surface 24 of the mold core 22 to fill the part cavity 36 with the liquid material. As shown in FIGS. 2A and 2B, the runner 32 and the sprue 34 and the part cavity 36 are each partially defined by the mold core. Those structures 32, 34, 36 may be completed by another part such as a cavity plate (not shown in the figures).

The method 200 also includes 206 restricting the flow of liquid material through a gate 38 between the runner 32 and the part cavity 36. As shown in FIGS. 2A and 2B, the gate 38 provides the fluid path into the part cavity 36. As shown in FIG. 4C, the gate 38 may be formed to spread-out or to distribute the liquid material across a large section of the part cavity 36. The gate 38 may also function to restrict the flow rate of the liquid material into the part cavity 36, allowing for a more consistent quality in the molded part 10.

The method 200 also includes 208 hardening the liquid material within the part cavity 36 to form the molded part 10 having the shape of the part cavity 36. This step may involve cooling the liquid material 10 until it solidifies within the part cavity 36.

The method 200 also includes 210 retracting a hydraulic ram 74 by a hydraulic cylinder 72 to cause a block 76 to move in a direction parallel to the lower surface 26. This is illustrated in the motion between FIG. 2A to step 2B.

The method 200 also includes 212 pulling a first ejector plate 66 away from the mold core 22 by the block 76 by the retraction of the hydraulic ram 74. This is also illustrated in the motion between FIG. 2A to step 2B. This step may be performed similarly to the function of a traditional ejector pin and may use one or more conventional ejector pin actuation mechanisms.

The method 200 also includes 214 pulling a first pin 56 through a first bore 60 in the mold core 22 away from the gate 38 by the pulling of the first ejector plate 66 by the retraction of the hydraulic ram 74. This is also illustrated in the motion between FIG. 2A to step 2B.

The method 200 also includes 216 pulling a plunger 64 through a plunger cavity 52 in fluid communication with the gate 38 by the pulling of the first ejector plate 66 by the retraction of the hydraulic ram 74. This is also illustrated in the motion between FIG. 2A to step 2B. The plunger cavity 52 may extend directly into the gate 38 as shown on the FIGS. Alternatively, the plunger cavity 52 may extend into another structure connected to the gate, such as a runner 32.

The method 200 also includes 218 drawing a quantity of the liquid material from the gate 38 into the plunger cavity 52 by the pulling of the plunger 64 through the plunger cavity 52 after the part cavity 36 is filled with the liquid material and before the liquid material within the part cavity 36 has completely hardened, and thereby reducing the pressure of the liquid material within the gate 38 and within the part cavity 36 proximate to the gate 38.

The method 200 also includes 220 hardening the liquid material within the gate 38 and within the plunger cavity 52 into a slug 82. The slug 82 is best shown in FIGS. 4A and 4C and is integrally formed with the hardened material in the gate 38.

The method 200 also includes 222 pushing the first pin 56 through the first bore 60 in the mold core 22 toward the gate to cause the plunger 64 to eject the slug 82 and the hardened material attached thereto from the mold core 22. This step 222 is facilitated by the geometry of the plunger cavity 52, preferably having a uniform cross-section 54 such as the rectangular shape illustrated in FIGS. 3B and 4B.

The method 200 also includes 224 pushing a second pin 84 by a second ejector plate 94 through a second bore 88 in the mold core 22 and in contact with the hardened material attached to the molded part 10 away from the first pin 56 to remove the hardened material from the mold core 22. This step 224 may be similar or identical to the functionality of an ejector pin used in traditional injection molding.

The method 200 also includes 226 retracting the second pin 84 into the second bore 88 in the mold core 22 away from the upper surface 24 by a second retainer plate 94 attached to the second ejector plate 92 after removing the hardened material from the mold core 22.

Obviously, many modifications and variations of the present invention are possible in light of the above teachings and may be practiced otherwise than as specifically described while within the scope of the appended claims.

What is claimed is:

1. A molding apparatus for making a molded part comprising:
a mold core extending between a lower surface and an upper surface defining a runner for transferring liquid material to a part cavity to form the molded part, with a gate providing fluid communication between the runner and the part cavity;
the mold core including an inner surface defining a plunger cavity extending into the mold core from the upper surface and open to the gate;
a first pin including a first shaft extending transverse to the lower surface through a first bore in the mold core to a plunger slidably disposed within the plunger cavity and sealingly engaging the inner surface to draw the liquid material from the gate into the plunger cavity to reduce a fluid pressure within the gate.

2. The molding apparatus for making a molded part as set forth in claim 1, wherein the gate is a fan gate having a generally trapezoidal cross-section parallel to the lower surface, and extending between a narrow edge adjoining the runner and a wide edge larger than the narrow edge adjoining the part cavity, and the fan gate having a generally trapezoidal cross-section perpendicular to the lower surface extending from a thick end adjoining the runner to a thin end adjoining the part cavity.

3. The molding apparatus for making a molded part as set forth in claim 1, wherein the plunger cavity has a uniform cross-section parallel to the upper surface and open to the gate.

4. The molding apparatus for making a molded part as set forth in claim 3, wherein the uniform cross-section of the plunger cavity is rectangular.

5. The molding apparatus for making a molded part as set forth in claim 3, wherein the uniform cross-section of the plunger cavity is trapezoidal.

6. The molding apparatus for making a molded part as set forth in claim 1, wherein the first bore extends into the plunger cavity, and wherein the plunger cavity has a cross-section larger than a cross-section of the first bore.

7. The molding apparatus for making a molded part as set forth in claim 1, further including:
a base plate having a generally flat shape parallel to and spaced apart from the lower surface of the mold core; and
a first ejector plate disposed within an ejector compartment between the base plate and the lower surface of the mold core and engaging a first head of the first pin opposite the plunger and being movable transverse to the lower surface for pushing the first pin into the first bore of the mold core.

8. The molding apparatus for making a molded part as set forth in claim 7, further including:
a hydraulic cylinder to move a hydraulic ram causing the first pin to move away from the upper surface, and to thereby cause the plunger to move into the plunger cavity, pulling liquid material from the gate and reducing the internal pressure within the gate.

9. The molding apparatus for making a molded part as set forth in claim 1, further including:
a second pin including a second shaft extending transverse to the lower surface through a second bore in the mold core to the upper surface of the mold core to engage one of the runner or a sprue or the molded part for removal from the mold core after the liquid material therein has solidified.

10. The molding apparatus for making a molded part as set forth in claim 9, further including:
a second ejector plate disposed within an ejector compartment adjacent the lower surface of the mold core and engaging a second head of the second pin opposite the second shaft and being movable transverse to the lower surface for pushing the second pin into the second bore of the mold core.

11. A molding apparatus for making a molded part comprising:
a mold core extending between an upper surface and a lower surface;
the upper surface of the mold core defining a runner for transferring liquid material to a part cavity to form the molded part, with a gate providing fluid communication between the runner and the part cavity;
the mold core including an inner surface defining a plunger cavity extending into the mold core from the upper surface;
a first pin including a first shaft extending through a first bore in the mold core to a plunger slidably disposed within the plunger cavity and sealingly engaging the inner surface to draw the liquid material into the plunger cavity; and
a second pin including a second shaft extending through a second bore in the mold core to the upper surface of the mold core to engage one of the runner or the sprue or the molded part.

12. The molding apparatus for making a molded part as set forth in claim 11, wherein the plunger cavity has a uniform cross-section parallel to the upper surface.

13. The molding apparatus for making a molded part as set forth in claim 11, wherein the plunger cavity extends into the gate.

14. A method for making a molded part with a molding apparatus comprising:
providing a mold core having a generally rectangular block shape extending between an upper surface and a lower surface;
transferring liquid material through a runner to a part cavity within the upper surface of the mold core to fill the part cavity with the liquid material;
conveying the liquid material through a gate between the runner and the part cavity;
hardening the liquid material within the part cavity to form the molded part having the shape of the part cavity;
pulling a first pin through a first bore in the mold core away from the gate;
pulling a plunger through a plunger cavity in fluid communication with the gate by the pulling of the first pin through a first bore in the mold core;
drawing a quantity of the liquid material from the gate into the plunger cavity by moving the plunger through the plunger cavity before the liquid material within the part cavity has completely hardened, and thereby reducing the pressure of the liquid material within the gate.

15. The method for making a molded part with a molding apparatus as set forth in claim 14, further including:
hardening the liquid material within the gate and within the plunger cavity into a slug;
pushing the first pin through the first bore in the mold core toward the gate to cause the plunger to eject the slug and the hardened material attached thereto from the mold core.

16. The method for making a molded part with a molding apparatus as set forth in claim 14, further including:
pushing a second pin by a second ejector plate through a second bore in the mold core and in contact with the hardened material attached to the molded part away from the first pin to remove the hardened material from the mold core.

17. The method for making a molded part with a molding apparatus as set forth in claim 16, further including:
retracting the second pin into the second bore in the mold core away from the upper surface by a second retainer plate attached to the second ejector plate after removing the hardened material from the mold core.
